(19) United States
(12) Patent Application Publication
(10) Pub. No.: US 2008/0072174 A1
(43) Pub. Date: Mar. 20, 2008

(54) Apparatus, system and method for the aggregation of multiple data entry systems into a user interface

(76) Inventors: Kevin M. Corbett, Rescue, CA (US); Brian D. Johnson, Portland, OR (US); William D. Boyle, Morgan Hill, CA (US)

Correspondence Address: INTEL CORPORATION;c/o INTELLEVATE, LLC, P.O. BOX 52050, MINNEAPOLIS, MN, 55402, US

(21) Appl. No.: 11/521,925

(22) Filed: Sep. 14, 2006

(51) Int. Cl. G06F 9/00

(52) U.S. Cl. 715/810

(57) ABSTRACT

An apparatus, system and method that allow for the aggregation of multiple data entry systems via a user interface. An embodiment of an apparatus includes a processor to receive a control signal from a navigation controller and to display a user interface on a display device. The user interface includes a menu having one or more menu selections provided by a content and/or service provider. Based on the control signal the processor to activate one of the one or more menu selections to display a data entry funnel, where the data entry funnel to pull one or more required data entry fields for a process to collect data required to access the activated selection. Other embodiments are described and claimed.

### BACKGROUND

Television (TV) display user interfaces have design lay outs to receive information from a standard TV remote control. However, navigation and/or manipulation of a today's user interfaces are slow and confusing via a standard TV remote control. This is especially true when multiple content and/or service providers present highly customized and varied templates to a user requesting that they provide registration and billing data in order for the user to purchase their content and/or services.

### BRIEF DESCRIPTION OF THE DRAWINGS

FIG. 1 illustrates one embodiment of a user interface.

FIG. 2 illustrates one embodiment of a user interface.

FIG. 3 illustrates one embodiment of a user interface.

FIG. 4 illustrates one embodiment of a user interface.

FIG. 5 illustrates one embodiment of a navigation controller.

FIG. 6 illustrates one embodiment of a system.

FIG. 7 illustrates one embodiment of a system.

FIG. 8 illustrates one embodiment of a logic flow.

FIG. 9 illustrates one embodiment of a device.

### DETAILED DESCRIPTION

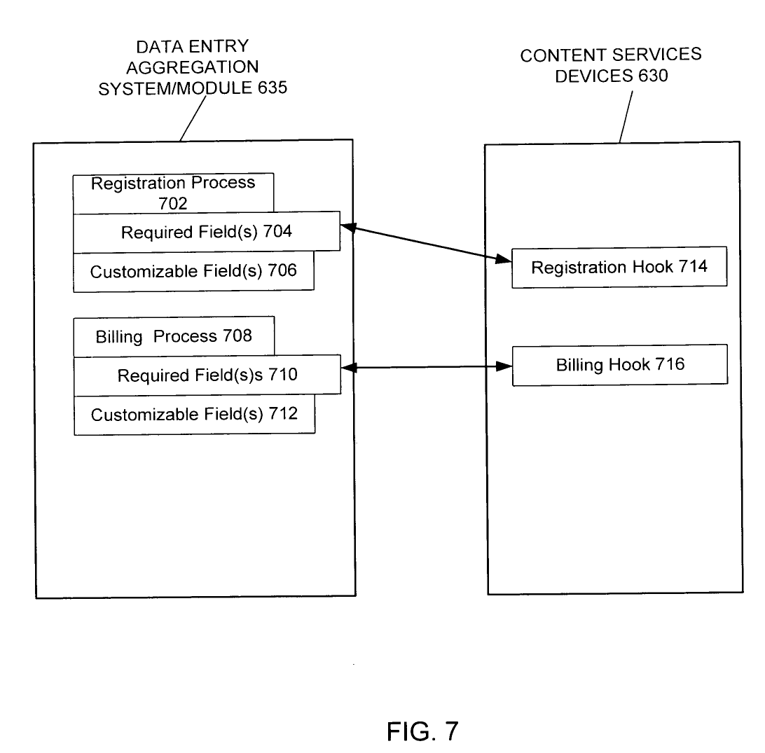

Various embodiments may be generally directed to a user interface that allows for the aggregation of multiple data entry systems. In one embodiment, for example, one or more content and/or service providers utilize a data entry aggregation system/module to set up required (changeable over time) and customized fields to request data from a user in order for the user to access their content and/or services. A user interface includes a navigation section that may provide navigation for TV content and/or service browsing. The navigation section initially displays a navigation menu having one or more menu selections. Based on the particular menu selection that is activated, it is determined whether a content and/or service provider requires user data to access the activated selection. If so, a data entry funnel is displayed on the user interface that pulls the required and customized fields from the data entry aggregation system/module for the particular content and/or service provider. The data entry funnel collects the user data and provides it to the content and/or service provider. The user is then returned to the user interface to where he or she was prior to activating the selection. This allows for multiple content and/or service providers to aggregate multiple data entry processes that are necessary for a worldwide content and services delivery system into a single architecture and business process. Here, the user does not lose track of where he is in his experience due to only the partial covering of the user interface with the data entry funnel and due to the user being returned to the user interface at the location he was prior to activating the selection. In addition, the user or consumer's experience is kept fairly consistent regardless of the content and/or service provider's desired data from the user. This consumer experience may be, for example, a “living room experience” via a television or a “mobile experience” via any handheld or mobile device such as an ultra mobile PC or the device described below with reference to FIG. 7. The approach affords a maximum amount of flexibility for the content and/or service provider to get critical data from the user for processes such as registration and billing, but does not confuse or interrupt the user's browsing or enjoyment. Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

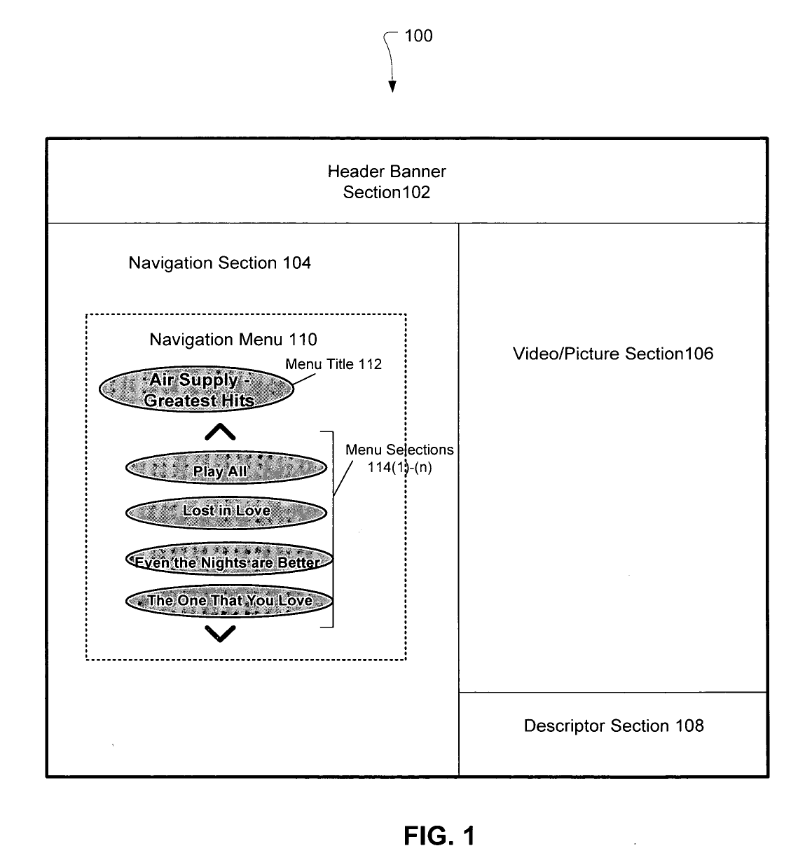

FIG. 1 illustrates one embodiment of a user interface 100. User interface 100 may comprise a header banner section 102, a navigation section 104, a video/picture section 106 and a descriptor section 108. User interface 100 may be displayed on a display device, for example. Each of these sections is described next in more detail.

Header banner section 102 may be used to display a high-level title for user interface 100. Video/Picture section 106 displays content, where the content may include shows or programs, graphics, video games, books, and so forth. In an embodiment, the content is received via one or more of broadcast, cable and satellite television feeds. Related voice, audio, music, etc., may also be presented with the displayed content in section 106. Descriptor section 108 informs the user of the content provided in video/picture section 106. For example, descriptor section 108 may provide related guide data such as content name, channel or location (e.g., location on the Internet via an Internet Protocol (IP) address or Uniform Resource Location (URL), location on a local hard disk, etc.), type of content (e.g., broadcast, stream, download, etc.), metadata (e.g., content description, year of release, ratings information, category, etc.), air time, a brief synopsis, stars, and so forth. Again, related voice, audio, music, etc., may also be presented with the displayed content in section 108. These examples are not meant to limit the invention.

Navigation section 104 may comprise a navigation menu 110. Navigation menu 110 may provide navigation for TV content and/or service browsing. Navigation menu 110 may comprise virtual keys or buttons that are used to navigate user interface 100. The virtual keys of menu 110 may comprise one or more indicia thereon. The virtual keys may comprise any type of indicia to represent any type of information. The indicia may comprise, for example, graphics, icons, letters, characters, symbols, and/or functions. The indicia also may be user defined, for example. In one embodiment, the indicia may comprise characters and/or symbols similar to the characters and/or symbols found in conventional keyboards. The indicia may also comprise information pulled or dynamically updated from other software applications or connected services such as, but not limited to, buddy lists, email contacts, cell phone books, device locations, and so forth. The indicia may also be company or content brands and/or third party trademarked or copyrighted materials. This allows indicia to be pulled from a varied set of information provided by existing applications and/or services which would allow the text entry to be familiar, graphically recognizable and efficient. The various embodiments described herein, however, are not limited in the context of the embodiment illustrated in FIG. 1 as the indicia on the virtual keys may represent any predefined character, symbol, modifier, control, alternative, function, or shift keys.

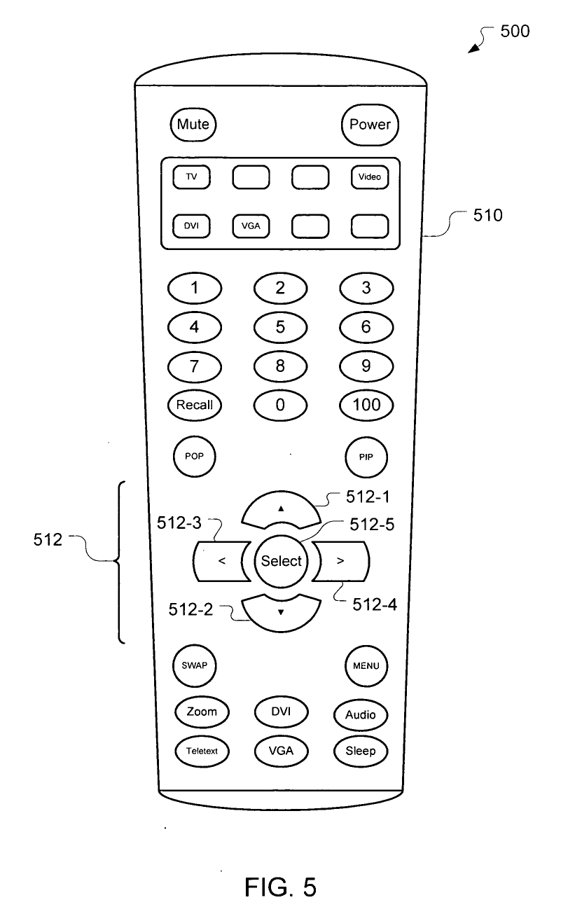

The virtual keys of navigation section 104 may be activated by a user via a navigation controller. In one embodiment, the navigation controller may be a pointing device or remote control, as will be described below with reference to FIG. 5.

Referring again to FIG. 1, navigation menu 110 may comprise a menu title 112 and one or more menu selections 114(1)-(n), where n is any positive integer. Menu selections 114(1)-(n) may be expandable. In an embodiment of the invention, the menu selections are fed to user interface 100 via dynamic feed (e.g., metadata, external XML strings, etc.).

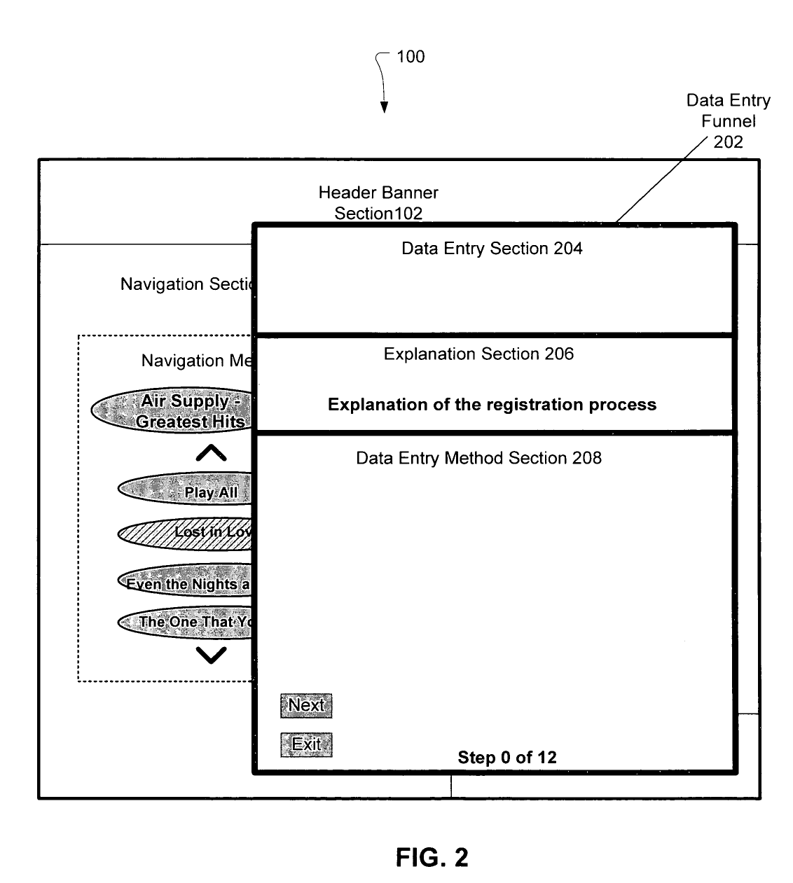

In the example user interface of FIG. 1, a content and/or service provider is offering for a user to download/purchase one or more songs. Menu title 112 is “Air Supply—Greatest Hits” and menu selections 114(1)-(n) or song selections include “Play All”, “Lost in Love”, “Even the Nights are Better” and “The One That You Love”. One or more of menu selections 114(1)-(n) may be activated when the user decides to download/purchase a song. If it is determined that the content and/or service provider requires the user to enter data (e.g., registration or billing data) in order for the user to access the activated selection or song, then a data entry funnel may be displayed over navigation menu 110. In some embodiments of the invention, the data entry funnel is displayed partially over navigation menu 110. An embodiment of a data entry funnel is illustrated in FIG. 2.

As illustrated in FIG. 2, menu selection or song “Lost in Love” was activated. In an embodiment of the invention, when menu selection “Lost in Love” is activated, it is determined whether a content and/or service provider requires user data to access the activated selection. If so, a data entry funnel 202 may be displayed on user interface 100 to partially cover user interface 100. Data entry funnel 202 pulls the required and customized fields from the data entry aggregation system/module for the particular content and/or service provider. Data entry funnel 202 collects the user data and provides it to the content and/or service provider. The user is then returned to the user interface to where he was prior to activating the selection. Here, the user does not lose track of where he is in his experience due to only the partial covering of user interface 100 with data entry funnel 202 and due to the user being returned to user interface 100 at the location he was prior to activating the selection. This example embodiment is provided for illustration purposes only and is not meant to limit the invention.

As illustrated in FIG. 2, data entry funnel 202 may include a data entry section 204, an explanation section 206 and a data entry method section 208. Data entry section 204 may include any means for accepting data from a user (e.g., one or more data entry boxes). Explanation section 206 provides the user with an explanation of the specific data entry process. Data entry method section 208 may display a data entry method that has been defined for a data entry box of section 204.

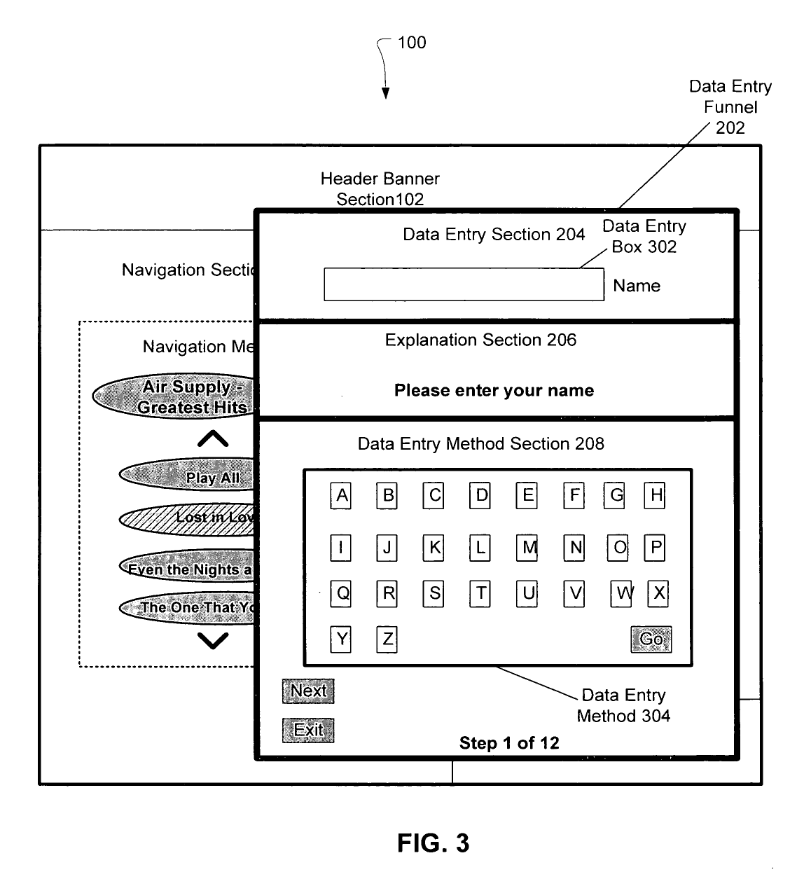

For example, as illustrated in FIG. 2, data entry funnel 202 shows a registration process that may be required from the user when he activates menu selection “Lost in Love”. Explanation section 206 may initially provide an overall explanation of a registration process (e.g., step 0 of 12 of the registration process). The user may then activate the “Next” button or virtual key on data entry funnel 202 to display step 1 of 12 of the registration process, as illustrated in FIG. 3.

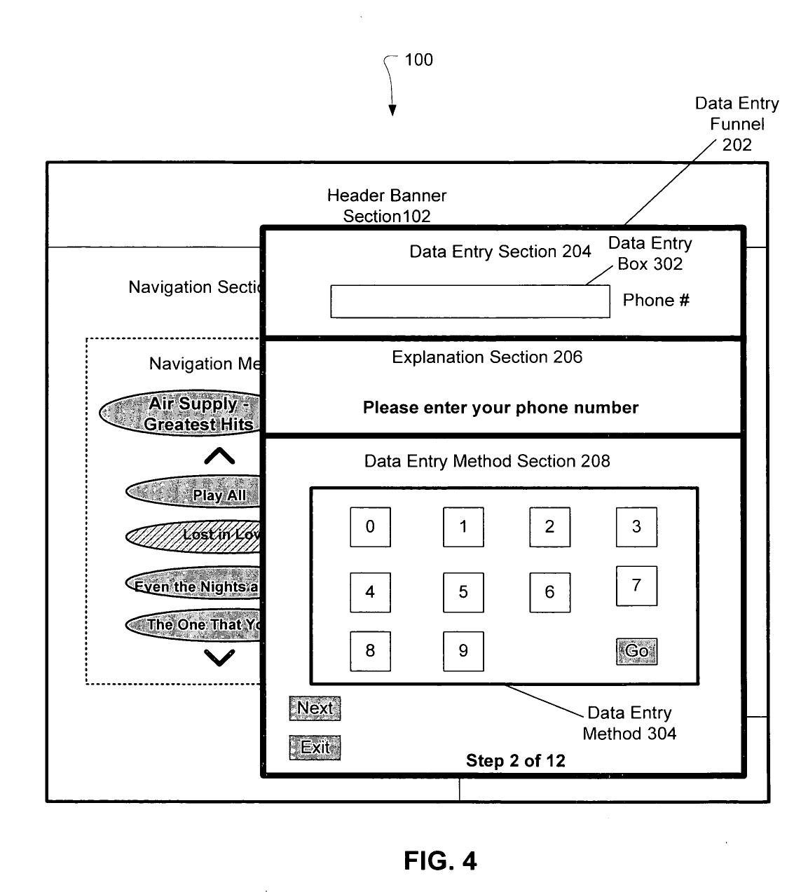

Referring to FIG. 3, step 1 of 12 requires the user to enter his name. Here, a data entry box 302 is displayed in data entry section 204. In an embodiment of the invention, a data entry method 304 is displayed in section 208 that is context and language specific to the current data entry box 302. Here, the applicable language and necessary selections or virtual keys required for the current data entry box 302 are determined. In an embodiment of the invention, data entry method 304 only displays the necessary virtual keys in the applicable language that the user needs to enter the data required by the current data entry box 302. This allows for data entry method 304 to facilitate the entry of data in any language. Additionally, the number and context of the virtual keys of data entry method 304 adjust for the type of data currently being asked of the user. For example, in FIG. 3, the “Name” data entry box is asking for the user to enter his or her name in English (as indicated by the data entry box and the text displayed in explanation section 206). Accordingly, data entry method 304 of FIG. 3 includes virtual keys for each letter of the English alphabet. In an embodiment of the invention, a “Go” key is also included in data entry method 304 that allows the user to indicate when he or she is finished entering the data. FIG. 4 illustrates example data entry method 304 that is context and language specific to the “Phone #” data entry box 302 in data entry section 204. Accordingly, data entry method 208 includes virtual keys for each number 0-9. These examples are provided for illustration purposes only and are not meant to limit the invention.

In an embodiment of the invention, data entry method 304, the data entry boxes of data entry section 204 and the text of explanation section 206 are fed via dynamic feed (e.g., metadata, external XML strings, and so forth). This flexible approach to data entry provides a simplified user experience as well as the freedom to easily and dynamically localize and update the on-screen data entry method when needed.

The virtual keys of data entry method 304 may comprise one or more indicia thereon. The virtual keys may comprise any type of indicia to represent any type of information. The indicia may comprise, for example, graphics, icons, letters, characters, symbols, and/or functions. The indicia also may be user defined, for example. In one embodiment, the indicia may comprise characters and/or symbols similar to the characters and/or symbols found in conventional keyboards. The indicia may also comprise information pulled or dynamically updated from other software applications or connected services such as, but not limited to, buddy lists, email contacts, cell phone books, device locations, and so forth. The indicia may also be company or content brands and/or third party trademarked or copyrighted materials. This allows indicia to be pulled from a varied set of information provided by existing applications and/or services which would allow the text entry to be familiar, graphically recognizable and efficient. The various embodiments described herein, however, are not limited in the context of the embodiment illustrated herein, as the indicia on the virtual keys may represent any predefined character, symbol, modifier, control, alternative, function, or shift keys. The virtual keys of data entry method 304 may be activated by a user via a navigation controller. In one embodiment, the navigation controller may be a pointing device or remote control, as will be described below with reference to FIG. 5.

In an embodiment of the invention, menu and data entry method selections may be expandable. Additionally, each of the menu and data entry method selections may represent any variable information. This selection information may be dynamic, adjustable and considered to be independent from any of the other menu and/or data entry method selections. For example, one or more data entry boxes in a data entry menu or virtual keys in a data entry method may be added, deleted or changed without affecting any other menu or data entry method. Selection information may also be pulled from one or more independent servers or IP services without affecting the consumer experience or the appearance of user interface 100 and/or menus described herein.

FIG. 5 illustrates one embodiment of a navigation controller 500. In one embodiment, navigation controller 500 may be a pointing device 510 that may be used to activate one or more keys of navigation section 104 (FIG. 1) and data entry funnel 202 (FIG. 2). Pointing device 510 may be any computer hardware component (specifically human interface device) that allows a user to input spatial (i.e., continuous and multi-dimensional) data into a computer. Many systems such as computer aided design (CAD), graphical user interfaces (GUI), and televisions and monitors allow the user to control and provide data to the computer or television using physical gestures—point, click, and drag—typically by moving wired or wireless pointing device such as a mouse, trackball, touchpad, pointing stick, light pen, joystick, head pointer, eye tracking device, digitizing tablet, data glove, remote controller, among others. Movements of pointing device 510 are echoed on a display device by movements of a pointer, cursor, focus ring, or other visual indicators displayed on the display device.

In the illustrated embodiment, pointing device 510 is a conventional remote control unit used to interact with audio/visual devices such as televisions, monitors, cable boxes, digital video disc (DVD) player, compact disc (CD) players, digital video recorders (DVR), video games, digital video camera, and/or digital still camera, among others, for example. Pointing device 510 comprises navigation buttons 512. In one embodiment, the navigation buttons 512 comprise an upward navigation button 512-1, a downward navigation button 512-2, a leftward navigation button 512-3, and a rightward navigation button 512-4. Navigation buttons 512 also may comprise a select button 512-5 to execute a particular function. Pointing device 510 may be a wireless remote that operates on wireless principles employing infra-red (IR) energy or radio frequency (RF) energy. In other embodiments, pointing device 510 may be hard wired to the display device, for example. The embodiments, however, are not limited to the elements or in the context shown or described in FIG. 5.

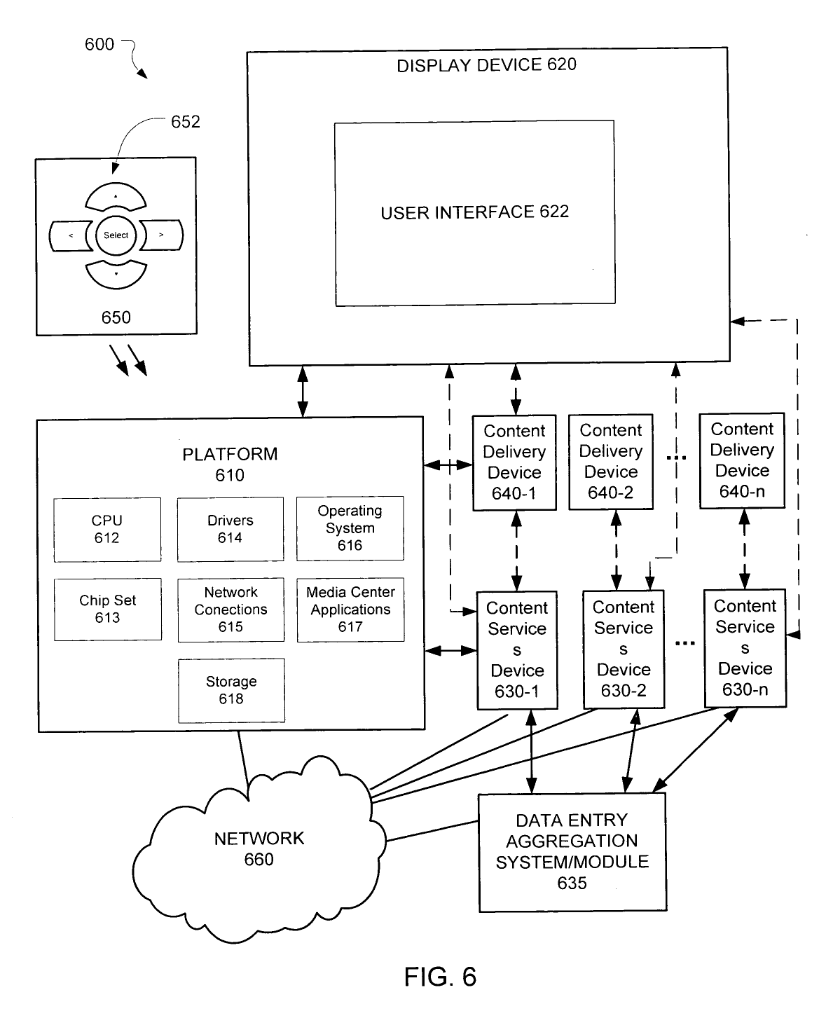

FIG. 6 illustrates one embodiment of a system 600. In one embodiment, system 600 may be a digital home entertainment system although system 600 is not limited in this context. In one embodiment, system 600 comprises a platform 610 coupled to a display device 620. In one embodiment, platform 610 may comprise or may be implemented as a media platform such as the Viiv™ media platform made by Intel® Corporation. In one embodiment, platform 610 may receive content from one or more content devices such as content services devices 630 (630-1 to 630-n) or one or more content delivery devices 640 (640-1 to 640-n) or other similar content source. In an embodiment of the invention, one or more of content services devices 630 may be hosted by any national, international and/or independent service and thus accessible to platform 610 via the Internet. One or more of content services devices 630 may be coupled to platform 610 and/or to display device 620. Platform 610 and/or content services devices 630 may be coupled to a network 660 to communicate (e.g., send and/or receive) media information to and from network 660. One or more of content delivery devices 640 also may be coupled to platform 610 and/or to display device 620.

In various embodiments, one or more of content services devices 630 may be coupled (e.g., either directly or via network 660) to a data entry aggregation system/module 635. Content and/or service providers may utilize one or more of content services devices 630 to provide services and/or products to a user via user interface 622 (or via user interface 100 in FIG. 1). The content and/or service providers may utilize data entry aggregation system/module 635 to set up required and customized fields to request data from a user in order for the user to access their content and/or services (e.g., registration and billing processes). An embodiment of data entry aggregation system/module 635 and content services devices 630 are described below in more detail with reference to FIG. 7.

In various embodiments, platform 610 and one or more of content services devices 630 may be integrated, or platform 610 and one or more of content delivery devices 640 may integrated, or platform 610, one or more of content services devices 630, and one or more of content delivery devices 640 may be integrated, for example. In various embodiments, platform 610 and display device 620 may be an integrated unit and display device, or one or more of content service devices 630 may be integrated, or display device 620 and one or more of content delivery devices 640 may integrated. A navigation controller 650 comprising one or more navigation buttons 652 may be used to interact with either platform 610 or display device 620, and/or both, for example.

In one embodiment, platform 610 may comprise a CPU 612, a chip set 613, one or more drivers 614, one or more network connections 615, an operating system 616, and/or a media center application 617 comprising one or more software applications, for example. Platform 610 also may comprise storage 618. Storage 618 may include control and content data used to define one or more navigation menus (e.g., navigation menu 110 of FIG. 1), one or more data entry funnels (such as funnel 202 of FIG. 2), one or more data entry methods (such as method 304 of FIG. 3), one or more text entry boxes, messages, and so forth. In an embodiment of the invention, data entry method 304, the data entry boxes of data entry section 204 and the text of explanation section 206 are fed via dynamic feed (e.g., metadata, external XML strings, and so forth, stored in storage 618). Storage 618 may also include the control and content data displayed in video/picture section 106 and descriptor section 108, as described above in FIG. 1.

In one embodiment, CPU 612 may comprise one or more processors such as dual-core processors. Examples of dual-core processors include the Pentium® D processor and the Pentium® processor Extreme Edition both made by Intel® Corporation, which may be referred to as the Intel Core Duo processors, for example.

In one embodiment, chip set 613 may comprise any one of or all of the Intel® 945 Express Chipset family, the Intel® 955X Express Chipset, Intel® 975X Express Chipset family, plus ICH7-DH or ICH7-MDH controller hubs, which all are made by Intel® Corporation.

In one embodiment, drivers 614 may comprise the Quick Resume Technology Drivers made by Intel® to enable users to instantly turn on and off platform 610 like a television with the touch of a button after initial boot-up, when enabled, for example. In addition, chip set 613 may comprise hardware and/or software support for 5.1 surround sound audio and/or high definition 7.1 surround sound audio, for example. Drivers 614 may include a graphics driver for integrated graphics platforms. In one embodiment, the graphics driver may comprise a peripheral component interconnect (PCI) Express graphics card.

In one embodiment, network connections 615 may comprise the PRO/1000 PM or PRO/100 VE/VM network connection, both made by Intel® Corporation.

In one embodiment, operating system 616 may comprise the Windows® XP Media Center made by Microsoft® Corporation. In one embodiment, one or more media center applications 617 may comprise a media shell to enable users to interact with content using navigation controller 650 (e.g., remote control) from a distance of about 10-feet away from platform 610 or display device 620, for example. In one embodiment, the media shell may be referred to as a “10-feet user interface,” for example. In addition, one or more media center applications 617 may comprise the Quick Resume Technology made by Intel®, which allows instant on/off functionality and may allow platform 610 to stream content to media adaptors or other content services devices 630 or content delivery devices 640 when the platform is turned “off.”

In one embodiment, storage 618 may comprise the Matrix Storage technology made by Intel® to increase the storage performance enhanced protection for valuable digital media when multiple hard drives are included, for example.

In one embodiment, display device 620 may comprise any television type monitor or display. Display device 620 may comprise, for example, a computer display screen, video monitor, television-like device, and/or a television. Display device 620 may be digital and/or analog.

In various embodiments, one or more of content services devices 630 may comprise a cable television box, personal computer, network, telephone, Internet enabled devices or appliance capable of delivering digital information and/or content, and any other similar device capable of unidirectionally or bidirectionally communicating content between content providers and platform 610 and/display device 620, via network 660. It will be appreciated that the content may be communicated unidirectionally and/or bidirectionally to and from any one of the components in system 600 and a content provider via network 660. Examples of content may include any media information including, for example, video, music, and gaming information. One or more of content services devices 630 may receive content such as cable television programming including media information, digital information, and/or other content. Examples of content providers may include any cable or satellite television or radio content providers and may include, for example, ESPN, Movielink, and MTV Overdrive for video; Napster, AOL and Tiscali for music; Gametap, Square Enix and T-Online for gaming; and YouTube and Flickr for sharing services.

In various embodiments, one or more of content delivery devices 640 may comprise a DVD player, CD player, DVR, video game, digital video camera, digital still camera, and/or MP3 (MPEG-1 Audio Layer 3 where MPEG stands for Moving Pictures Experts Group) player, among others, for example.

Platform 610 may receive content from network 660 directly or via one or more of content services devices 630. Platform 610 may receive content from one or more of content delivery devices 640. Under the control of one or more software applications, such as media center application 617, platform 610 displays user interface 622 (e.g., user interface 100) on display device 620.

In one embodiment, platform 610 may receive control signals from navigation controller 650 (e.g., navigation controller 500 of FIG. 5). Navigation buttons 652 (e.g., navigation buttons 512 of FIG. 5) may be used to interact with user interface 622. For example, under the control of software applications, e.g., media center applications 617, navigation buttons 652 located on navigation controller 650 may be mapped to the virtual navigation keys of navigation section 104 (FIG. 1) and data entry funnel (FIG. 2).

In various embodiments, system 600 may be implemented as a wireless system, a wired system, or a combination of both. When implemented as a wireless system, system 600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 600 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 610 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 6.

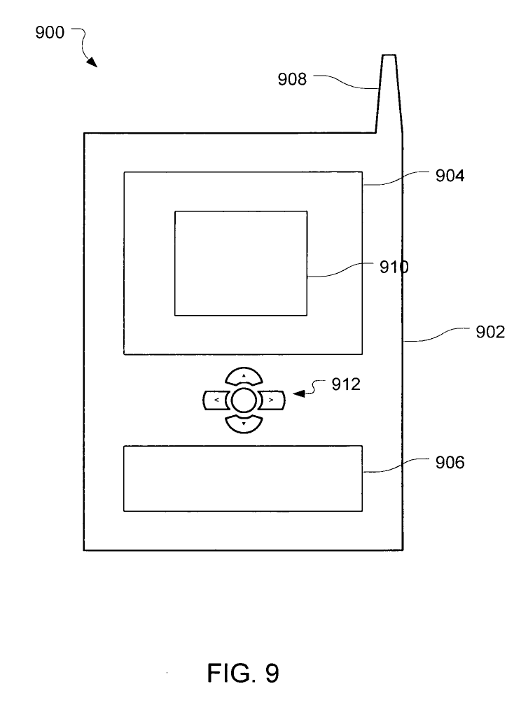

As discussed above, content and/or service providers may utilize data entry aggregation system/module 635 to set up required and customized fields to request data from a user via data entry funnel 202 (FIG. 2) in order for the user to access their content and/or services (e.g., registration and billing processes). This allows for multiple content and/or service providers to aggregate multiple data entry processes that are necessary for a worldwide content and services delivery system into a single architecture and business process. Here, the user or consumer's experience is kept fairly consistent regardless of the content and/or service providers' desired data from the user. This consumer experience may be, for example, a “living room experience” via a television or a “mobile experience” via any handheld or mobile device such as an ultra mobile PC or the device described below with reference to FIG. 9. Referring to FIG. 7, an embodiment of data entry aggregation system/module 635 and content services devices 630 are described in more detail. Here, data entry aggregation system/module 635 consists of one or more data entry processes (e.g., registration process 702 and billing process 708). Each process has one or more required fields, such as required field(s) 704 and 710, and one or more customizable fields, such as fields 706 and 712. Although not meant to limit the invention, example customizable fields may include billing information required by particular countries or client side language pack specification.

Each content services device 630 that utilizes data entry aggregation system/module 635 may have a hook into a process defined in system/module 635 (e.g., registration hook 714 into registration process 702 and a billing hook 716 into billing process 708). In some embodiments, one or more content services devices 630 may also include content/service browsing play lists and delivery systems. When the content and/or service provider requires a user to enter data, content services device 630 may be used to access data entry aggregation system/module 635 to determine the required and customizable fields for data entry funnel 202 (FIG. 2) that will be displayed to the user for data entry. The approach affords a maximum amount of flexibility for the content and/or service provider to get critical data from the user for processes such as registration and billing, but does not confuse or interrupt the user's browsing or enjoyment. The registration and billing processes shown in FIG. 7 are provided for illustration purposes only and are not meant to limit the invention. In fact, system/module 635 may include any data entry process.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof.

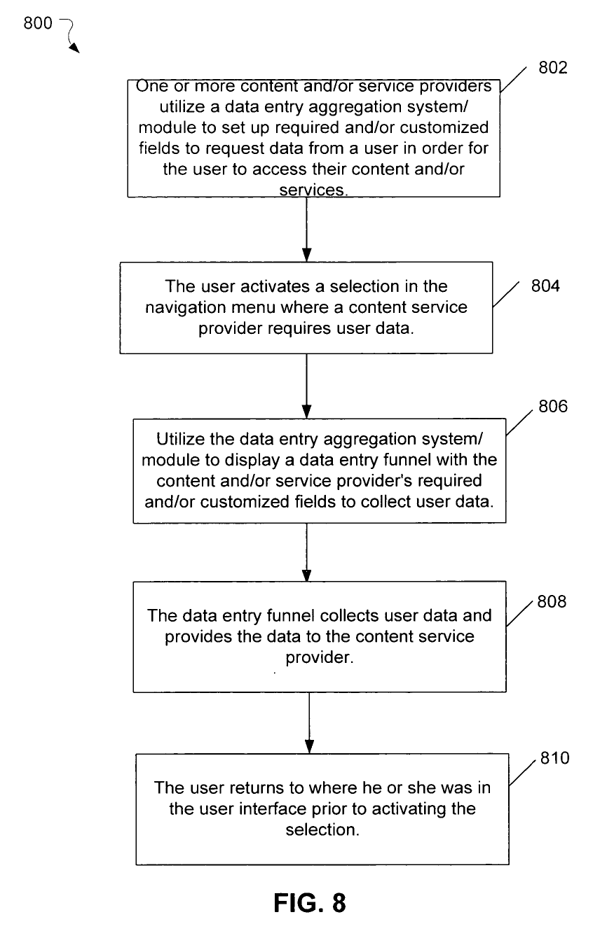

FIG. 8 illustrates one embodiment of a logic flow 800. The logic flow 800 may be representative of the operations executed by one or more embodiments described herein, for example, the operations executed by system 600. In one embodiment, logic flow 800 may be representative of the operations executed by a processor (e.g., the CPU 612) under the control of one more software applications (e.g., media center applications 617). Platform 610 comprising processor 612 provides the necessary information to display device 620 to map user interface 622 on display device 620.

As shown in logic flow 800, at block 802, one or more content and/or service providers utilize a data entry aggregation system/module (such as system/module 635 of FIGS. 6 and 7) to set up required and/or customized fields to request data from a user in order for the user to access their content and/or services. As described above, this allows for multiple content and/or service providers to aggregate multiple data entry processes that are necessary for a worldwide content and services delivery system into a single architecture and business process.

A user may activate or select one of the menu selections via a pointing device or remote control (such as pointing device 510 of FIG. 5), at block 804. The activated selection may require data entry by a content and/or service provider in order for the user to access the activated selection. If so, a data entry funnel (such as funnel 202 of FIG. 2) is displayed on the user interface (such as user interface 100 of FIG. 1) that pulls the required and customized fields from the data entry aggregation system/module for the particular content and/or service provider, at block 806. The data entry funnel collects the user data and provides it to the content and/or service provider, at block 808. The user is then returned to the user interface to where he or she was prior to activating the selection, at block 810. The embodiments, however, are not limited to the elements or in the context shown or described in FIG. 8.

FIG. 9 illustrates one embodiment of a device 900. In one embodiment, for example, device 900 may comprise a communication system. In various embodiments, device 900 may comprise a processing system, computing system, mobile computing system, mobile computing device, mobile wireless device, computer, computer platform, computer system, computer sub-system, server, workstation, terminal, personal computer (PC), laptop computer, ultra-laptop computer, portable computer, handheld computer, personal digital assistant (PDA), cellular telephone, combination cellular telephone/PDA, smart phone, pager, one-way pager, two-way pager, messaging device, and so forth. The embodiments are not limited in this context.

In one embodiment, device 900 may be implemented as part of a wired communication system, a wireless communication system, or a combination of both. In one embodiment, for example, device 900 may be implemented as a mobile computing device having wireless capabilities. A mobile computing device may refer to any device having a processing system and a mobile power source or supply, such as one or more batteries, for example. Examples of a mobile computing device may include a laptop computer, ultra-laptop computer, portable computer, handheld computer, palmtop computer, personal digital assistant (PDA), cellular telephone, combination cellular telephone/PDA, smart phone, pager, one-way pager, two-way pager, messaging device, data communication device, and so forth. Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In one embodiment, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 9, device 900 may comprise a housing 902, a display 904, an input/output (I/O) device 906, and an antenna 908. Device 900 also may comprise a five-way navigation button 912. I/O device 906 may comprise a suitable keyboard, a microphone, and/or a speaker, for example. Display 904 may comprise any suitable display unit for displaying information appropriate for a mobile computing device. I/O device 906 may comprise any suitable I/O device for entering information into a mobile computing device. Examples for I/O device 906 may include an alphanumeric keyboard, a numeric keypad, a touch pad, input keys, buttons, switches, rocker switches, voice recognition device and software, and so forth. Information also may be entered into device 900 by way of microphone. Such information may be digitized by a voice recognition device. The embodiments are not limited in this context.

Device 900 may comprise a user interface 910 that may be displayed on display 904 similar to user interface 100 discussed herein.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a processor to receive a control signal from a navigation controller and to display a user interface on a display device, wherein the user interface includes a menu having one or more menu selections provided by a content and/or service provider, and based on the control signal the processor to activate one of the one or more menu selections to display a data entry funnel, wherein the data entry funnel to pull one or more required data entry fields for a process to collect data required to access the activated selection.

2. The apparatus of claim 1, wherein the data entry funnel to pull the one or more required data entry fields and one or more customized data entry fields to collect data required to access the activated selection.

3. The apparatus of claim 2, wherein the one or more required data entry fields and the one or more customized data entry fields are established by the content and/or service provider via a data entry aggregation system.

4. The apparatus of claim 1, wherein the data entry funnel to send the collected data to the content and/or service provider.

5. The apparatus of claim 1, wherein the process is a billing process.

6. The apparatus of claim 1, wherein the process is a registration process.

7. The apparatus of claim 1, wherein the navigation controller is a remote control device.

8. A method, comprising:
displaying a user interface on a display device, wherein the user interface includes a menu having one or more menu selections provided by a content and/or service provider; and
activating one of the one or more menu selections via a navigation controller to display a data entry funnel, wherein the data entry funnel to pull one or more required data entry fields for a process to collect data required to access the activated selection.

9. The method of claim 8, wherein the data entry funnel to pull the one or more required data entry fields and one or more customized data entry fields to collect data required to access the activated selection.

10. The method of claim 9, wherein the one or more required data entry fields and the one or more customized data entry fields are established by the content and/or service provider via a data entry aggregation system.

11. The method of claim 8, wherein the data entry funnel to send the collected data to the content and/or service provider.

12. The method of claim 8, wherein the process is a billing process.

13. The method of claim 8, wherein the process is a registration process.

14. The method of claim 8, wherein the navigation controller is a remote control device.

15. A system, comprising:
a content device; and
a processor to receive a control signal from a navigation controller and to display a user interface on a display device, wherein the user interface includes a menu having one or more menu selections provided by a content and/or service provider, and based on the control signal the processor to activate one of the one or more menu selections to display a data entry funnel, wherein the data entry funnel to pull one or more required data entry fields for a process to collect data required to access the activated selection.

16. The system of claim 15, wherein the data entry funnel to pull the one or more required data entry fields and one or more customized data entry fields to collect data required to access the activated selection.

17. The system of claim 16, wherein the one or more required data entry fields and the one or more customized data entry fields are established by the content and/or service provider via a data entry aggregation system.

18. The system of claim 15, wherein the data entry funnel to send the collected data to the content and/or service provider.

19. The system of claim 15, wherein the process is a billing process.

20. The system of claim 15, wherein the process is a registration process.

21. The system of claim 15, wherein the navigation controller is a remote control device.

22. A machine-readable medium containing instructions which, when executed by a processing system, cause the processing system to perform a method, the method comprising:
displaying a user interface on a display device, wherein the user interface includes a menu having one or more menu selections provided by a content and/or service provider; and
activating one of the one or more menu selections via a navigation controller to display a data entry funnel, wherein the data entry funnel to pull one or more required data entry fields for a process to collect data required to access the activated selection.

23. The machine-readable medium of claim 22, wherein the data entry funnel to pull the one or more required data entry fields and one or more customized data entry fields to collect data required to access the activated selection.

24. The machine-readable medium of claim 23, wherein the one or more required data entry fields and the one or more customized data entry fields are established by the content and/or service provider via a data entry aggregation system.

25. The machine-readable medium of claim 22, wherein the data entry funnel to send the collected data to the content and/or service provider.

26. The machine-readable medium of claim 22, wherein the process is a billing process.

27. The machine-readable medium of claim 22, wherein the process is a registration process.

28. The machine-readable medium of claim 22, wherein the navigation controller is a remote control device.
